(19) United States
(12) Patent Application Publication
(10) Pub. No.: US 2024/0109218 A1
(43) Pub. Date: Apr. 4, 2024

(54) CUTTING-OFF MACHINE FOR THE TRANSVERSAL CUTTING OF LOGS OF PAPER MATERIAL

(71) Applicant: FUTURA S.P.A., Capannori (IT)

(72) Inventors: Gabriele BETTI, Capannori (IT); Massimo MENICHETTI, Capannori (IT)

(21) Appl. No.: 18/275,007

(22) PCT Filed: Jan. 14, 2022
(86) PCT No.: PCT/IT2022/050002

§ 371 Date: Jul. 30, 2023

(30) Foreign Application Priority Data
Feb. 2, 2021 (IT) 102021000002093

(51) Int. Cl. B26D 7/12; B26D 3/16

(52) U.S. Cl. CPC B26D 7/12; B26D 3/16; B26D 2210/11

(57) ABSTRACT

Cutting-off machine for the transversal cutting of logs of paper material, comprising:
a structure (SC) on which are moved the logs;
a cutting unit (CU) with a blade (2);
a grinding unit for sharpening the blade;
a device for positioning the grinding wheels with respect to the blade (2);
   wherein
the positioning device comprises a primary carriage (4) and two secondary carriages (42, 43) driven by respective actuators;
there is an optical sensor (100) that detects a cutting edge (200) of the blade (2);
in a phase of operative positioning of the grinding wheels which involves sharpening the blade following the contact of the grinding wheels with the blade, the abrasive side of the grinding wheels is pushed against the blade with a thrust having a predetermined value.

The present invention relates to a cutting-off machine for the transversal cutting of logs made of paper material.

It is known that rolls of toilet paper, kitchen paper and paper for similar uses are obtained from the transversal cutting of rolls of greater length, commonly called “logs” and produced by machines called “rewinders” in which a predetermined quantity of a paper material, consisting of one or more overlapping paper plies, is wrapped around itself, or around cardboard tubes called “cores”. Generally, the logs produced by the rewinders are conveyed to a buffer magazine and, from this, to machines, called “cutting-off machines” which perform the aforementioned transversal cut. Generally, the cutting-off machines have a platform on which guide channels for the logs are defined and, downstream of said channels, a cutting unit which includes a disk blade suitably activated and moved to determine the transversal cut of the logs at a programmed rate according to the length of the rolls to be obtained from the logs. The blades are normally associated with grinding wheels which cyclically intervene to restore the cutting profile of the blades themselves. Periodically, the blades of the cutting-off machines must be replaced due to wear which progressively reduces both the diameter and the cutting performances. Whenever a worn blade is replaced with a new one, the position of the grinding wheels relative to the blade must be adjusted.

EP3194128B1 discloses a machine for the transversal cutting of logs of paper material comprising an advancement path for the logs to be cut, a cutting unit with a replaceable disk-shaped blade supported in such a way as to be able to rotate around its own axis while it is subjected to a cyclic movement for cutting the logs and to allow the advancement of the logs along said advancement path, and a sharpening unit with two. grinding wheels configured and controlled to intervene on the disc-shaped blade when the latter is to be sharpened. The grinding wheels are mounted on a support system which comprises a mechanism for controlled approach of the grinding wheels to the blade configured to move each grinding wheel in a direction substantially parallel to its own axis of rotation. Said mechanism acts in such a way as to bring a support slide of each grinding wheel into a nominal position with respect to the blade, and to bring the sharpening wheel close to the blade in a controlled manner by moving the grinding wheel with respect to the relative slide which is kept in said nominal position.

The main object of the present invention is to propose a machine for cutting logs in which the positioning of the sharpening wheels with respect to the blade being sharpened from time to time is automated and in which this positioning is substantially independent of the diameter of the blade.

A further object of the present invention is to provide a sharpening mechanism for the blades used in cutting-off machines for the transversal cutting of logs of paper material which allows to eliminate, or at least drastically reduce, the so-called “polygonalization” of the blades themselves, i.e. a phenomenon whereby the blades, due to the repeated grinding operations to which they are normally subjected, lose their original circular shape and assume a substantially polygonal shape which determines an incorrect execution of the transversal cut of the logs.

This result has been achieved, in accordance with the present invention, by adopting the idea of making a machine having the characteristics indicated in claim 1. Other characteristics of the present invention are the subject of the dependent claims.

Thanks to the present invention, it is possible to perform the positioning of the grinding wheels automatically, in shorter times than the positioning performed manually and with greater operational safety since this operation does not require operators to access the area of the machine that houses the blade. Furthermore, a device for positioning the grinding wheels in a machine according to the present invention has a relatively simple structure and integrates an effective mechanism for recognizing the desired position for the grinding wheels. Moreover, a machine in accordance with the present invention avoids, or in any case reduces, the so-called polygonalization of the blade even if the positioning of the grinding wheels determined by the primary carriage is not particularly precise. These and further advantages and characteristics of the present invention will be more and better evident to every person skilled in the art thanks to the following description and the attached drawings, provided by way of example but not to be considered in a limiting sense, in which:

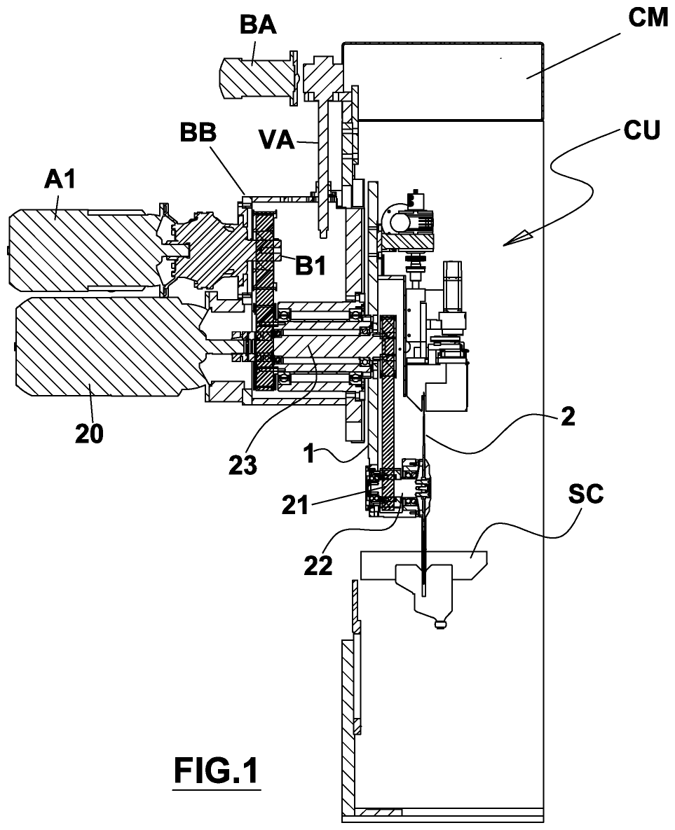

FIG. 1 represents a schematic vertical sectional view of the cutting station of a cutting-off machine for the transversal cutting of logs of paper material with a cutting unit in accordance with the present invention;

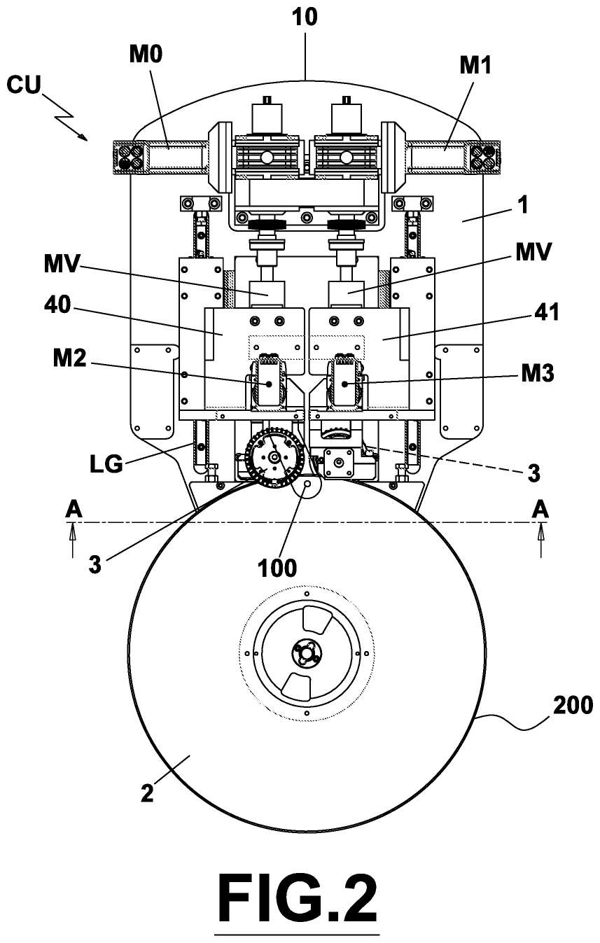

FIG. 2 represents a schematic front view of a cutting unit for cutting-off machines according to the present invention;

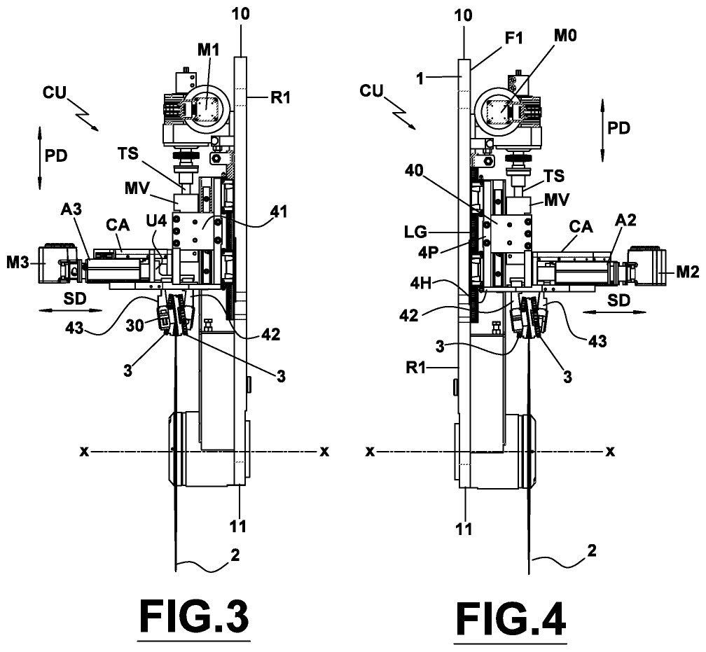

FIGS. 3 and 4 represent two schematic side views of the cutting unit of FIG. 2;

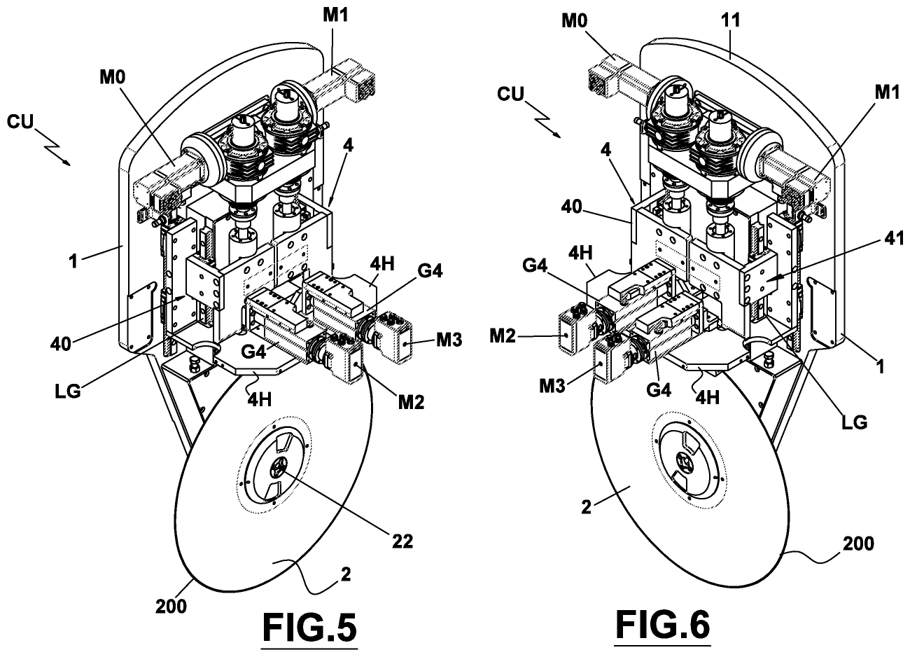

FIGS. 5 and 6 represent two schematic perspective views of the cutting unit shown in FIG. 2;

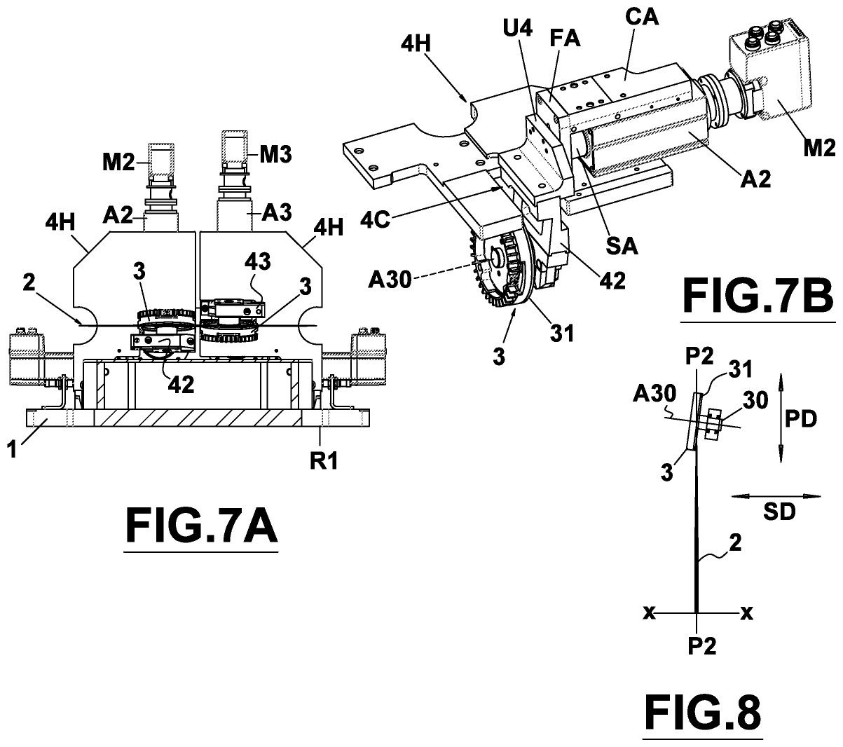

FIG. 7A represents a section view along the line A-A of FIG. 2;

FIG. 7B is a perspective view of a secondary carriage with the respective moving means;

FIG. 8 is a diagram illustrating a possible orientation of a grinding wheel with respect to the plane (P2) of the blade (2);

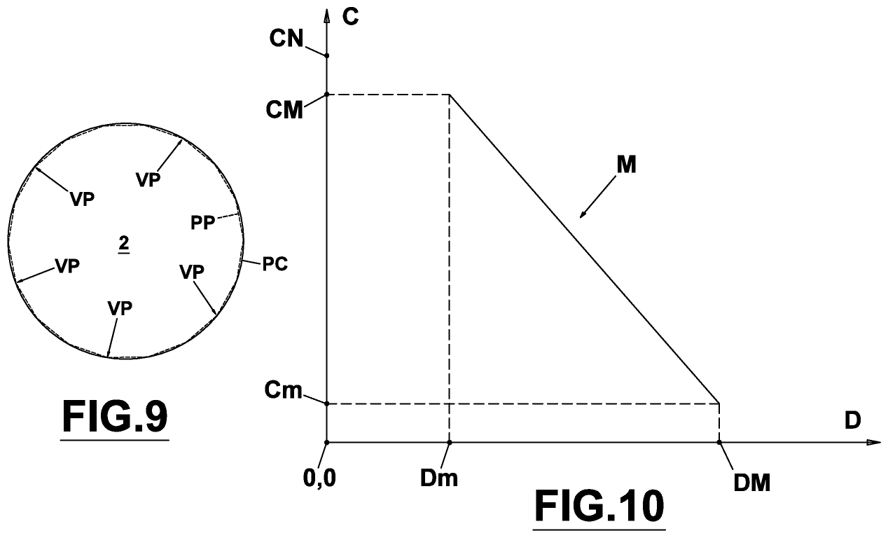

FIG. 9 is a diagram representing the polygonalization of a blade;

FIG. 10 is a qualitative graph representing a possible variation of the torque provided by the drive motors of the grinding wheels in the cutting unit represented in the previous figures as the diameter of the blade subjected to sharpening varies;

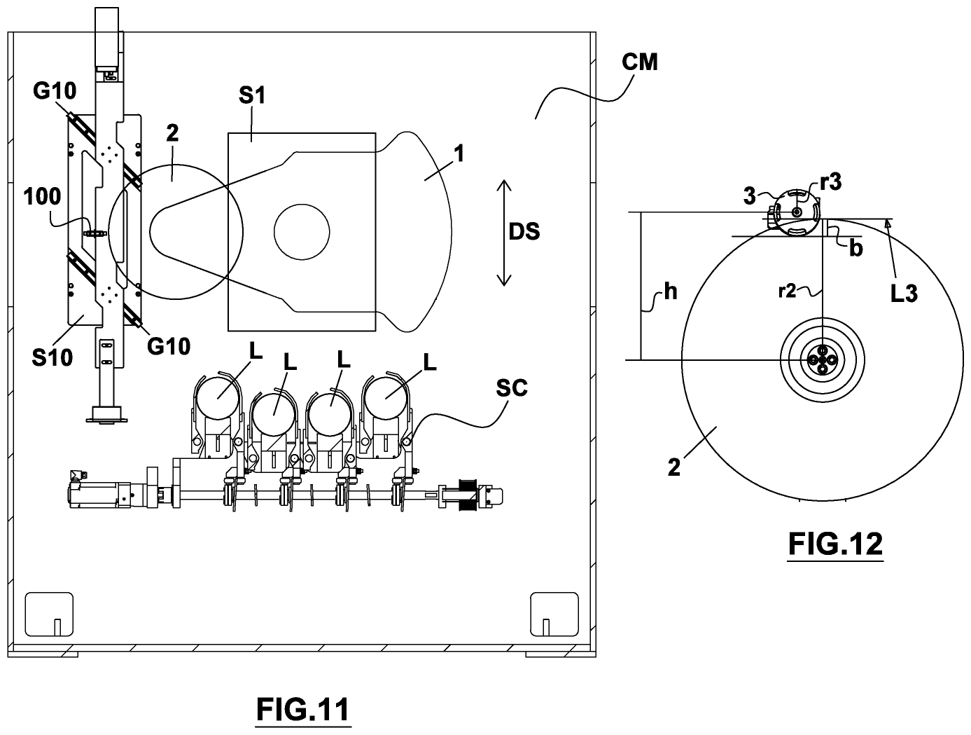

FIG. 11, in which the logs subjected to cutting are indicated with the reference “L”, schematically represents a further embodiment of the present invention;

FIG. 12 is a diagram that represents some geometric parameters relating to the position of the grinding wheels with respect to the blade of the cutting unit;

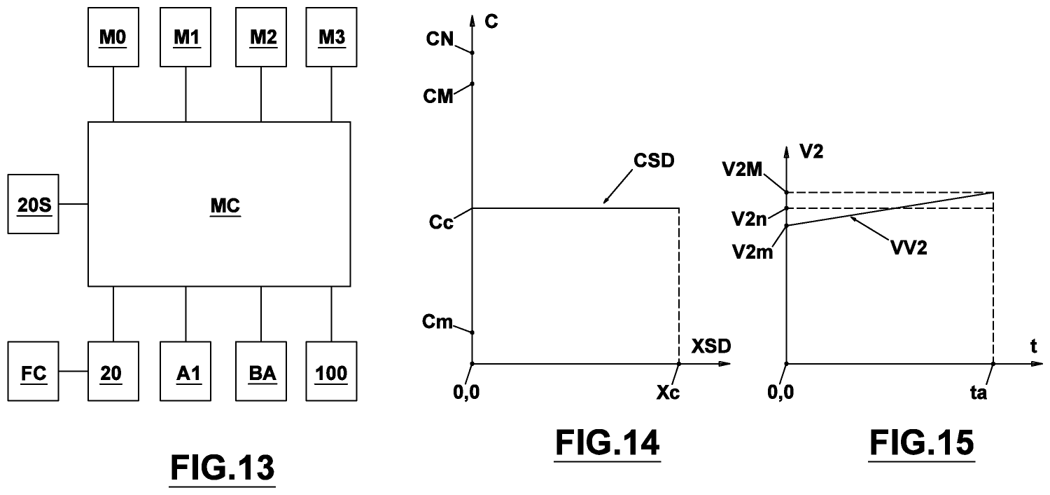

FIG. 13 represents a simplified block diagram of a possible control system for the actuators of a cutting unit in a machine according to the present invention;

FIG. 14 is a qualitative graph which represents the constant value of the torque provided by the motors of the secondary actuators during the stroke of the secondary carriages;

FIG. 15 is a qualitative graph that represents a possible way for controlling the rotation speed of the blade during the sharpening phase.

Reduced to its essential structure and with reference to the figures of the attached drawings, a cutting-off machine to which a cutting unit is applicable according to the present invention is of the type comprising:
a structure (SC) on which are moved the logs to be cut transversely in order to obtain rolls of shorter length;
a cutting unit (CU) arranged at a predetermined point of said structure (SC) and comprising a support plate (1) for a blade (2) which can be removably connected to a respective rotary actuator (20) arranged at one end of said plate (1) and able to determine the rotation of the blade itself around its own axis (x-x) with a predetermined speed, said plate (1) being in turn constrained to a further actuator which drives it into rotation with predetermined angular speed around an axis parallel to the rotation axis (x-x) of the blade (2);
a sharpening unit with two wheels (3) suitably provided to sharpen the blade (2);
a device for positioning said grinding wheels (3) relative to the blade (2).

FIG. 1 schematically illustrates the main elements of a cutting-off machine (CM) in which a cutting unit in accordance with the present invention can be mounted, it being understood that the drawing is provided solely to allow the location of the cutting unit to be identified with respect to the path of the logs. It is also understood that the structure of the cutting-off machine can be made in any suitable way as long as it is aimed at the transversal cutting of logs of paper material, to obtain rolls of shorter length, by means of a cutting unit comprising a blade which acts transversely to the logs.

In the example of FIG. 1, in accordance with a per se known construction scheme, the rotary actuator (20) is connected to the blade (2) by means of a belt (21) which connects the central pin (22) of the same blade to the shaft (23) of the actuator (20) through a pulley arranged on the free end of the shaft (23). Furthermore, the plate (1) is rotated around an axis parallel to the axis of rotation of the blade (2), by means of a corresponding rotary actuator (A1) whose shaft (B1) is parallel to the shaft (23) of the actuator (20) which controls the rotation of the blade (2). The actuator (20), which for example is an electric motor, is integral with a box-shaped body (BB) located above the structure (SC) and inside which the belt (21) and the shafts (23) and (B1) are arranged. Said body (BB) is connected to a corresponding actuator (BA) which, through a screw (VA) acting on a nut bushing arranged on an upper side of the same body (BB), controls its vertical position, i.e. its positioning with respect to the underlying structure (SC). Consequently, by controlling the position of the body (BB), the blade (2) can be positioned at the desired height with respect to the structure (SC). The actuator (A1), which for example consists of an electric motor, is also integral with the body (BB).

In practice, the blade (2) rotates around a respective axis (x-x) which is parallel to the axis of rotation of the plate (1).

A cutting unit (CU) according to a possible embodiment of the present invention comprises a plate (1) with an upper side (10), a lower side (11), a front side (F1) and a rear side (R1). The central pin (22) of the circular blade (2) is mounted on the lower side (11) of the plate (1) and is removably applied to this pin in order to allow the blade to be replaced when necessary. The blade (2) is oriented parallel to the plate (1) and is positioned at a predetermined distance from the front side (F1) of the latter. Also mounted on the plate (1) are two grinding wheels (3) for sharpening the blade (2) and a device for positioning said grinding wheels (3) relative to the blade (2). Each grinding wheel (3) is applied on a respective support shaft (30) whose axis (A30) has an inclination of a predetermined value with respect to the front side (F1) of the plate (1) and, consequently, with respect to a corresponding face of the blade (2). In the diagram of FIG. 8 the spindle (30) supporting a grinding wheel (3), the respective axis (A30), the inclination of this grinding wheel (3) in the sharpening position with respect to a face (A2) of the blade (2) and the plane (P2) of the latter are shown.

In accordance with the present invention, said grinding wheels (3) positioning device comprises:
a primary carriage (4) movable parallel to the plate (1) according to a primary movement direction (PD);
two secondary carriages (42, 43) constrained to the primary carriage (4) and individually movable according to a secondary movement direction (SD) orthogonal to said primary movement direction (PD), each secondary carriage (42, 43) having a seat for the support of the shaft (30) of a respective grinding wheel (3).

In practice, the primary movement direction (PD) is a direction parallel to the plane (P2) where the blade (2) lies, i.e. a radial direction with respect to the latter, while the secondary movement direction (SD) is a direction parallel to the axis (x-x) of rotation of the blade (2).

In accordance with the example of implementation shown in the drawings, the primary carriage (4) consists of two independent units (40, 41) to each of which a corresponding secondary carriage (42, 43) is constrained. Alternatively, the primary carriage can consist of a single unit on which both the secondary carriages (42, 43) are constrained.

With reference to the example of embodiment shown in FIGS. 2-7, the primary carriage (4) consists of two independent units, each of which consists of a body (40, 41) constrained to the internal side (F1) of the plate (1) by means of a linear guide (LG) allowing its guided sliding along the primary movement direction (PD). The sliding of each body (40, 41) along the primary movement direction (PD) is controlled by a corresponding electric motor (M0, M1). Each motor (M0, M1) is fixed on the internal side (F1) of the plate (1) and drives a threaded shaft (TS) which engages a corresponding nut bushing (MV) formed on each body (40, 41). Therefore, each body (40, 41) can be moved by the respective motor (M0, M1) along the primary movement direction (PD). Each of said bodies (40, 41) has a first side (4P) parallel to the internal side (F1) of the plate (1) and a second side (4H) orthogonal and below the first side (4P). The first side (4P) slides along the respective guide (LG). The second side (4H) constitutes a cantilever structure whose function is indicated below. In practice, each of said bodies (40, 41), seen laterally, has a structure with a part (4P) parallel to the internal side (F1) of the plate (1) and a part (4H) orthogonal to the same internal side (F1) of the plate (1) so as to define a bracket above the blade (2). In the example described above, the movement of the bodies (40, 41), that is, the movement of the two units that make up the primary carriage (4), is a guided movement thanks to the presence of the guides (LG) that constrain the bodies (40, 41) to the inner side (F1) of the plate (1).

In accordance with the example shown in the attached drawings, each of the secondary carriages (42, 43) is positioned below a respective bracket (4H) and has an upper vertical appendage (U4) passing through a longitudinal slot (4C) made on the same bracket. The motors (M2, M3) are positioned above the brackets (4H), so that each motor (M2, M3) is fixed to the upper surface of a corresponding bracket (4H) through the outer casing of a respective linear actuator (A2, A3) driven by the same motor (M2, M3). Each actuator (A2, A3) is, for example, a screw actuator known per se, i.e. an actuator comprising a stem (SA) moved by a screw (not visible in the drawings) operated by the respective motor (M2, M3). The stem (SA) is attached to a flange (FA) which on its rear side is fixed to a slide (CA) mounted on an upper face of the actuator casing, while on its front side it is fixed to the vertical appendage (U4) of the respective carriage (42, 43).

The shafts (30) of the grinding wheels (3) are each fixed to a respective secondary carriage (42, 43). In this way, each motor (M2, M3) moves the respective secondary carriage (42, 43) in the secondary direction (SD) along the lower side of a bracket (4H). And since the secondary carriages are linked to the primary carriage, each secondary carriage, and consequently the respective grinding wheel, can be moved along both the primary (PD) and the secondary direction (SD).

In other words, each grinding wheel (3) is supported by the cutting unit (CU) in such a way that it can be moved both according to the primary movement direction (PD) and according to the secondary movement direction (SD). In fact, the bodies (40, 41) that make up the primary carriage (4) can be moved according to the direction (PD) by means of the motors (M0, M1), while the secondary carriages (42, 43) can be moved on the primary carriage along the direction (SD) by means of the motors (M2, M3).

The grinding wheels (3) are oriented with their respective abrasive sides (31) towards the plane (P2) where the blade (2) lies.

The primary carriage can be provided, in correspondence with its lower side, i.e. the side facing the blade (2), with an optical sensor (100) whose function is described below. For example, said optical sensor (100) can be mounted below the bracket (4H) of any of the bodies (40, 41) previously described. For example, the optical axis of the sensor (100) is spaced by a predetermined value (b) from a reference line, which can be the so-called “sinking line” (L3) of the grinding wheels (3), so as to intercept the cutting edge (200) of the blade (2), when the primary carriage approaches the latter, before the grinding wheels (3) are placed in the sharpening position on the blade. The sinking line is a reference line of each grinding wheel (3), which is a known geometric parameter supplied by the manufacturer. This parameter identifies the correct position of the grinding wheel with respect to the blade for sharpening purposes. In practice, for a correct sharpening of the blade, the sinking line of the grinding wheel must be in a position of tangency to the cutting edge of the blade, as shown in the diagram of FIG. 12. In this condition, the abrasive side of the grinding wheel interferes correctly with the area of the blade to be sharpened, i.e. an optimal contact condition is created between the grinding wheel and the blade during the sharpening phase. In accordance with the embodiment described above, the movement of the primary carriage (4) along the primary direction (PD) is controlled by the sensor (100) that detects the real diameter of the blade (2), so that, regardless of the real diameter of the latter, the grinding wheels (3) are brought into a position of correct sharpening, in which the sinking line of the grinding wheels is tangent to the cutting edge of the blade. With reference to the diagram in FIG. 12, in a first phase of operational positioning of the grinding wheels (3), the movement of the primary carriage (4) is controlled by means of the sensor (100) which detects the radius of the blade (2) and controls the interruption of the stroke of the primary carriage along the primary direction (PD) when the grinding wheels are arranged with their respective axes, relative to the axis of the blade, at a distance (h) equal to the radius (r2) of the blade increased by the radius (r3) of the wheels and decreased by a predetermined value (b). It is noted that the radius (r3) of the grinding wheels (3) is a known value. Similarly, the value (b) is a known value, provided by the manufacturer of the grinding wheels, which defines the position of the reference line (L3) with respect to the edge of the grinding wheel or, equivalently, with respect to its axis. In practice, the aforementioned value (b) measures the difference, along the primary direction (PD) of movement of the primary carriage, between the position of the optical sensor (100) projected on the plane (P2) of the blade (2) and the position of the sinking line (L3) of the grinding wheels (3) projected on the same plane (P2).

In accordance with the present invention, during the movement of the secondary carriages (42, 43) along the direction (SD) to bring the grinding wheels (3) into contact with the blade (2), and therefore in the sharpening phase, the respective motors (M2, M3) are controlled in such a way as to provide a predetermined torque. In other words, the motors (M2, M3) are controlled in such a way that each grinding wheel (3) exerts a thrust of a predetermined amount on the blade (2) during the sharpening phase. Yet in other words, in a second step of operational positioning of the grinding wheels (3), they are pushed towards the blade (2) by applying a thrust of a predefined amount which is maintained during the sharpening phase.

In the context of the present description, the first step of operational positioning of the grinding wheels (3) corresponds to the stroke of the same grinding wheels towards the blade (2) along the primary direction (PD), while the second step of operational positioning of the grinding wheels (3) corresponds to the stroke of the same grinding wheels towards the blade (2) along the secondary direction (SD).

In the diagram shown by way of example in FIG. 13 the electric motors (M2, M3) are controlled by a programmable control unit (MC) to which the motors (M0) and (M1), the sensor (100), the motor (20) and the rotary actuator (A1) are also connected. In this diagram, a sensor (20S) which detects the rotation speed of the blade (2) is also connected to the control unit (MC).

A possible operating mode of the device described above is as follows.

To sharpen the blade mounted on the cutting unit, the primary carriage is moved along the primary direction (PD) to perform the first operational positioning phase of the grinding wheels (3). Then, the optical sensor (100) detects the edge (200) of the blade (2), and the stroke of the primary carriage stops, for example when the sensor (100) has passed the said edge (200) by a value corresponding to the value (b) previously described. To this end, the optical sensor (100) is connected to the motors (M0, M1) through the programmable control unit (MC). In this way, the grinding wheels (3) are positioned as desired, spaced from the two sides of the blade (2) for the subsequent sharpening phase. At this point, the secondary carriages (42, 43) are moved along the secondary direction (SD) by the motors (M2, M3) for the execution of the second operational positioning phase of the grinding wheels, so that each grinding wheel (3) is brought with the respective abrasive side (31) in contact with a corresponding side of the blade (2) which is made to rotate around its own axis (x-x). This contact (in jargon said “home” position identification) is detected through the same blade (2) which, in fact, undergoes a slowdown as a result of the contact itself. Normally the motor (20) that drives the blade is controlled by a system equipped with a control function (FC) which guarantees a constant rotation speed of the blade around the axis (x-x) during the transversal cutting of the logs. When the grinding wheel positioning device is in operation, whereby the grinding wheels are moved along the direction (SD) as previously mentioned, the aforementioned motor control function (20) is temporarily deactivated. The contact of the grinding wheels (3) with the blade (2) causes the latter to slow down and this condition is assumed as an indicator of the contact between the wheels and the blade. When this condition is detected, the thrust exerted on the grinding wheels (3) is not interrupted, that is, this thrust is maintained throughout the sharpening phase. For this purpose, the torque of the motors (M2, M3) is controlled in such a way as to be maintained at the predetermined value throughout the sharpening phase of the blade (3). Since during the sharpening phase the grinding wheels (3) are pushed in an actively controlled way towards the blade (2), the vibrations normally caused by the contact of the grinding wheels with the rotating blade are reduced and therefore the contact between the blade. and the grinding wheels is improved. This avoids the so-called “polygonalization” of the cutting edge of the blade and allows to obtain more precise cross cuts of the logs and to optimize the wear of the blade which is an expensive component of the cutting unit. As previously described, by “polygonalization” it is meant a phenomenon such that the blade, following the repeated grinding operations to which it is normally subjected before being replaced, loses its original circular shape and assumes a substantially polygonal shape. In the schematic representation of FIG. 9 the solid line (PC) represents the ideal circular profile of the blade (2) while the dashed line (PP) represents the profile of the polygonalized blade. In FIG. 9 the dotted line profile (PP) of the blade (2) is deliberately amplified to highlight its non-circular shape. In FIG. 9 the references “VP” indicate some vertices of the polygonal shape assumed by the blade due to the polygonalization effect. In an alternative embodiment, the identification of the “home” position, that is, the contact position of the grinding wheels with the blade, is operated differently: in the phase of approaching the grinding wheels to the blade, the motors (M2, M3) are controlled to provide a predetermined limited torque as during sharpening and the control function (FC) of the motor (20) that moves the blade is not deactivated, so that the contact between the grinding wheels and the blade is identified by the stop of the motors (M2, M3) resulting from the contact between the grinding wheels and the blade. In any case, during the sharpening phase the grinding wheels are pushed towards the blade with a constant thrust force.

Preferably, the motors (M2, M3) move the secondary carriages (42, 43) by means of a mechanical transmission, in particular a screw transmission as in the example described above, which avoids, or in any case drastically reduces, the possibility that the grinding wheels bounce during sharpening. In other words, the use of mechanical linear actuators, for example actuators of the type described above, which determine the movement of the secondary carriages through a screw driven by an electric motor, is preferable to linear actuators of the pneumatic type in which the rebound of the grinding wheels against the blade may be more likely to occur.

Since the stroke of the primary carriage towards the blade (2) is controlled by the optical sensor (100) which detects the cutting edge (200) of the blade, the stopping point of the primary carriage at the end of this stroke is not predefined but depends on the diameter and therefore depends on the degree of wear of the blade mounted in the cutting unit.

In practice, in a first phase of operational positioning of the grinding wheels (3), the movement of the primary carriage (4) is controlled by means of an optical sensor (100) which detects the cutting edge (200) of the blade (2), so that the first operational positioning phase of the grinding wheels (3) implies a stroke of the primary carriage (4) whose length is correlated to the real diameter of the blade (2). And, in a second step of positioning of the grinding wheels (3), the secondary carriages (42, 43) are controlled so as to bring the abrasive side of the wheels (3) into contact with the blade (2).

In accordance with the present invention, during the second step of operational positioning of the grinding wheels (3), the motors (M2, M3) are controlled so as to provide a fixed and predetermined torque. In fact, the applicant observed that this mode of control of the motors (M2, M3) during the second phase of positioning of the grinding wheels (3) determines a more correct sharpening of the blade (2) and this even if the first phase of operative positioning, made by means of the primary carriage, was affected by an error (for example, if the positioning determined by the activation of the primary carriage controlled by the sensor 100 was affected by an error of 0.5 mm or, more generally, by an error between 0 mm and 3 mm), avoiding the so-called polygonalization of the blade.

More generally, in accordance with the present invention, as previously mentioned, during the sharpening of the blade (2) the grinding wheels (3) are pushed towards the same blade with a thrust of a predefined and controlled value, by means of the actuators that move the carriages on which the grinding wheels are mounted. In the example described above, the actuators that move the secondary carriages are driven by electric motors (M2, M3) but, more generally, these actuators can be of any suitable type as long as they can be controlled in such a way as to be able to push the grinding wheels (2) towards the blade (3) along the secondary direction (SD) exerting a thrust of a predetermined and controlled value during sharpening.

The applicant also noted that it is preferable to modify the thrust exerted by the grinding wheels (3) on the blade (2) as the diameter of the latter decreases, while maintaining it constant during each sharpening phase. More specifically, it is preferable to increase the thrust exerted by the grinding wheels on the blade as the diameter of the latter is reduced. Experimental tests were conducted using a blade of the type having an initial diameter of 600 mm which gradually reduced during use to a final value of 480 mm due to wear. The motors (M2, M3) used during the tests were motors providing a nominal torque of 0.31 Nm. During the tests, the torque of the motors (M2, M3) was kept constant during each sharpening phase but with a predetermined increase in value at each subsequent sharpening phase (from 10% of the nominal value when the first sharpening on the not worn blade were executed to 90% of the nominal value when the last sharpening on the completely worn blade was carried out). The applicant believes that the constant and controlled thrust exerted by the grinding wheels on the blade during each sharpening contributes to stabilize the blade itself, reducing its vibrations and reducing the tendency to polygonization which is reduced thanks to the present invention. In other words, the constant thrust ensures that the grinding wheels are always correctly in contact with the blade during sharpening.

In FIG. 10 a qualitative graph is provided which illustrates a possible mode (M) of variation of the torque provided by the motors (M2, M3) as the diameter of the blade (2) varies according to the tests performed. In this graph, the symbols used have the following meaning:
C: couple
CN: nominal torque of the motors (M2, M3), equal to 0.31 Nm;
Cm minimum torque provided by the motors (M2, M3), equal to 10% of the nominal torque CN;
CM: maximum torque provided by the motors (M2, M3), equal to 90% of the nominal torque CN;
D: diameter
Dm minimum diameter of the blade (2), equal to 480 mm;
DM: maximum diameter of the blade (2), equal to 600 mm

The graph of FIG. 10 shows a substantially linear variation (M) of the torque provided by the motors (M1, M2) as the diameter of the blade (2) varies but it is understood that this variation can also be a non-linear variation.

Preferably, between one sharpening and the next sharpening, the rotation speed of the blade varies between a value lower than the nominal rotation speed (for example, 95%) and a value greater than the nominal rotation speed (for example, 105%). The applicant observed, in fact, that by combining the predefined and controlled thrust of the grinding wheels on the blade and varying the rotation speed of the latter within predefined limits, the polygonalization phenomenon is further contrasted.

The experimental tests were carried out by the applicant using a commercially available blade marketed with the commercial name Chromalit IKS 0610 and grinding wheels of the type K10R 150 grit marketed by International Knife & Saw, Inc.

In the diagram of FIG. 14 the horizontal segment (CSD) represents the constant value of the torque (Cc) provided by the motors (M1, M2) along the entire stroke of the secondary carriages up to contact with the blade, represented by the segment 0-Xc on the XSD axis. The values CN, CM, Cm on the ordinate axis C are those already indicated above with reference to the graph in FIG. 10. The “Cc” value represents the value of the torque provided by the motors (M1, M2) corresponding to the real diameter of the blade in accordance with what has been previously described.

In the diagram of FIG. 15 the inclined line (VV2) represents a possible variation of the blade rotation speed (V2) in a succession of sharpening operations performed between a time t=0 in which the blade rotation speed has a value (V2m) lower than the nominal speed (V2n), and a time (ta) in which the blade rotation speed has a value (V2M) greater than the nominal speed (V2n). In the example described above: V2m=0.95*V2n and V2M=1.05*V2n. FIG. 15 shows a linear speed variation of the blade rotation speed but it is understood that this variation can also be non-linear.

In relation to the description provided above, a cutting-off machine according to the present invention comprises:
a structure (SC) on which are moved the logs to be transversely cut in order to obtain rolls of shorter length;
a cutting unit (CU) arranged at a predetermined position of said structure (SC) and comprising a support plate (1) for a blade (2) that can be removably connected to a respective rotary actuator (20) arranged at one end of said plate (1) and is adapted to control the rotation of the blade around its own axis (x-x) with a predetermined speed, the blade (2) being arranged along a plane (P2) orthogonal to said axis of rotation (x-x) in a pre-established position in the cutting unit (CU);
a sharpening unit with two grinding wheels (3) adapted to sharpen the blade (2) on opposite sides with respect to said plane (P2) and equipped with an abrasive side (31);
a positioning device for positioning said grinding wheels (3) with respect to the blade (2), by means of which each grinding wheel (3) is arranged in a position of contact with the blade (2) in a step of sharpening the latter starting from an initial inoperative position;
   wherein
said positioning device comprises a primary carriage (4) that is movable along a primary direction (PD) radially with respect to the blade (2), starting from an initial waiting position, by means of one or more primary actuators (M0, M1), and two secondary carriages (42, 43) each of which is supported by the primary carriage (4) and is movable along a secondary direction (SD) parallel to the axis of rotation of the blade (2) by means of a corresponding secondary actuator (M2, A2; M3, A3);
in a first phase of operative positioning of the grinding wheels (3), said one or more actuators (M0, M1) used to move the primary carriage (4) are controlled by an optical sensor (100) which detects a cutting edge (200) of the blade (2) and interrupts the run of the primary carriage along the primary direction (PD) after this detection such that the run of the primary carriage (4) along the primary direction (PD) is correlated to the actual diameter of the blade (2); and
in a second phase of operative positioning of the grinding wheels (3) which involves sharpening the blade (2) following the contact of the grinding wheels with the blade, the secondary actuators are controlled, by means of a control unit (MC), so as to push the abrasive side of the grinding wheels (3) against the blade (2) with a thrust having a predetermined value.

In an embodiment of the invention which provides for the use of secondary actuators comprising two electric motors (M2, M3) to carry out the second operative positioning phase of the grinding wheels, preferably said motors are controlled in such a way as to provide a torque of predetermined value.

Furthermore, in accordance with the present invention, the thrust exerted by the grinding wheels (2) on the blade (3) is preferably related to the diameter of the latter, providing, in particular, an increase in said thrust as the diameter of the blade decreases. The blade, in fact, during its use is subject to wear and therefore its diameter is reduced. The present invention preferably provides for modifying the thrust exerted by the grinding wheels on the blade during the sharpening phase as a function of the diameter of the blade which constitutes a known value thanks to the detection performed by the sensor (100).

Therefore, in accordance with the present invention, a variable thrust value of the grinding wheels on the blade can be programmed as the diameter of the blade varies, by correspondingly programming the control on the actuators that drive the secondary carriages (42, 43). In an embodiment of the invention which provides for the use of actuators comprising electric motors (M2, M3) for moving the secondary carriages, a variable thrust value of the grinding wheels (2) on the blade (3) can be programmed as the diameter of the blade varies, by correspondingly programming the control of the drive provided by the electric motors (M2, M3).

Furthermore, preferably, between one sharpening phase and the next sharpening phase, the rotation speed of the blade varies between 95% and 105% of its nominal rotation speed.

The optical sensor (100) can be replaced by a sensor of another type, for example an inductive sensor or an ultrasonic sensor.

The cutting-off machine can also be provided with two sharpening units of the type described above. In this case, the two sharpening units are placed in different positions with respect to the blade (2) to each act on a different area of the latter. This can be useful in the case of large diameter circular blades, or circular blades with bevels of different shapes along the radius, in such a way that each sharpening unit can act on a corresponding area of the blade. Preferably, the two sharpening units are identical with each other.

With reference to the example shown in FIG. 11, the sensor (100) is associated with a slide (S10) mounted on guides (G10) oriented diagonally with respect to the movement direction (DS) of a further slide (51) on which the plate (1) is mounted. In a per se known manner, the plate (1) is lowered in the direction of the structure (SC) as a function of the diameter of the blade (2) detected by the sensor (100). As previously mentioned, the current diameter of the blade (2) is used to control the stroke of the primary carriage (4), not visible in FIG. 11, towards the same blade to sharpen it.

The sensor (100) detects the current diameter of the blade (2). In fact, the position of the center of the blade with respect to the plate (1) is known and invariable, so that the detection of the cutting edge of the blade corresponds to the detection of the diameter of the latter.

In the context of the present description, the primary actuators are the actuators which control the movement of the primary carriage along the primary direction, while the secondary actuators are the actuators which control the movement of the secondary carriages along the secondary direction.

In practice, the details of execution may in any case vary in an equivalent way as regards the individual elements described and illustrated without thereby departing from the idea of the solution adopted and therefore remaining within the limits of the protection granted by this patent in accordance with the following claims.

1) Cutting-off machine for the transversal cutting of logs of paper material, comprising:
a structure (SC) on which are moved the logs to be transversely cut in order to obtain rolls of shorter length;
a cutting unit (CU) arranged at a predetermined position of said structure (SC) and comprising a support plate (1) for a blade (2) that can be removably connected to a respective rotary actuator (20) arranged at one end of said plate (1) and is adapted to control the rotation of the blade around its own axis (x-x) with a predetermined speed, the blade (2) being arranged along a plane (P2) orthogonal to said axis of rotation (x-x) in a pre-established position in the cutting unit (CU);
a sharpening unit with two grinding wheels (3) adapted to sharpen the blade (2) on opposite sides with respect to said plane (P2) and equipped with an abrasive side (31);
a positioning device for positioning said grinding wheels (3) with respect to the blade (2), by means of which each grinding wheel (3) is arranged in a position of contact with the blade (2) in a step of sharpening the latter starting from an initial inoperative position;
wherein
said positioning device comprises a primary carriage (4) that is movable along a primary direction (PD) radially with respect to the blade (2), starting from an initial waiting position, by means of one or more primary actuators (M0, M1), and two secondary carriages (42, 43) each of which is supported by the primary carriage (4) and is movable along a secondary direction (SD) parallel to the axis of rotation of the blade (2) by means of a corresponding secondary actuator (M2, A2; M3, A3);
in a first phase of operative positioning of the grinding wheels (3), said one or more actuators (M0, M1) used to move the primary carriage (4) are controlled by an optical sensor (100) which detects a cutting edge (200) of the blade (2) and interrupts the run of the primary carriage along the primary direction (PD) after this detection such that the run of the primary carriage (4) along the primary direction (PD) is correlated to the actual diameter of the blade (2);
machine characterized in that
in a second phase of operative positioning of the grinding wheels (3) which involves sharpening the blade (2) following the contact of the grinding wheels with the blade, the secondary actuators are controlled, by means of a control unit (MC), so as to push the abrasive side of the grinding wheels (3) against the blade (2) with a thrust having a predetermined value.

2) Cutting-off machine according to claim 1 characterized in that said sensor (100) is constrained to the primary carriage (4).

3) Cutting-off machine according to claim 1, characterized in that the primary carriage is made by two independent units (40, 41).

4) Cutting-off machine according to claim 1 characterized in that the thrust exerted by the grinding wheels (2) on the blade (3) is increased as the diameter of the blade (2) decreases.

5) Cutting-off machine according to claim 1, wherein said secondary actuators are each driven by a corresponding electric motor, characterized in that in said second operating step of positioning the grinding wheels (3), said electric motors provide a predetermined torque.

6) Cutting-off machine according to claim 1 characterized in that said secondary actuators are each driven by a corresponding electric motor, characterized in that in said second operating step of positioning the grinding wheels (3), said electric motors provide a predetermined torque and the torque provided by said electric motors is increased as the diameter of the blade (2) decreases.

7) Cutting-off machine according to claim 1, characterized in that between a sharpening step of the blade and a subsequent sharpening step of the blade, the blade rotation speed varies between 95% and 105% compared to a predetermined nominal value.

8) Cutting-off machine according to claim 1 characterized in that the primary carriage is constrained to an internal side (F1) of the plate (1) by means of a linear guide (LG) which allows it to slide along the primary direction (PD).

9) Cutting-off machine according to claim 3, characterized by the fact that each of said independent units (40, 41) has a first side (4P) parallel to an internal side (F1) of the plate (1) and a second side (4H) orthogonal and underlying the first side (4P), in that said first side (4P) slides along a respective guide (LG), and in that said second side (4H) constitutes a bracket structure.

10) Cutting-off machine according to claim 1 characterized in that
the primary carriage is made by two independent units (40, 41)
each of said independent units (40, 41) has a first side (4P) parallel to an internal side (F1) of the plate (1) and a second side (4H) orthogonal and underlying the first side (4P), in that said first side (4P) slides along a respective guide (LG), and in that said second side (4H) constitutes a bracket structure, and
said secondary carriages (42, 43) are each arranged under a respective bracket structure (4H) of the primary carriage (4) and the secondary actuators are arranged above the same bracket structures (4H).

11) Cutting-off machine according to claim 1 characterized in that the contact between the abrasive side (31) of the wheels (3) and the blade (2) is detected by detecting a slowdown of the latter.

12) Cutting-off machine according to claim 1 characterized in that said secondary actuators are each driven by a corresponding electric motor, characterized in that in said second operating step of positioning the grinding wheels (3), said electric motors provide a predetermined torque and the contact between the abrasive side (31) of the grinding wheels (3) and the blade (2) is detected by detecting the stop of said electric motors.

13) Cutting-off machine according to claim 1 characterized in that said sensor (100) is an optical sensor or an inductive sensor or an ultrasonic sensor.
